(19) United States
(12) Patent Application Publication
(10) Pub. No.: US 2026/0145646 A1
(43) Pub. Date: May 28, 2026

(54) IN-VEHICLE IMAGING SYSTEM AND VEHICLE WINDOW GLASS

(71) Applicant: TOYOTA JIDOSHA KABUSHIKI KAISHA, Toyota-shi (JP)

(72) Inventor: Shuhei HORIMOTO, Toyota-shi (JP)

(73) Assignee: TOYOTA JIDOSHA KABUSHIKI KAISHA, Toyota-shi (JP)

(21) Appl. No.: 19/373,984

(22) Filed: Oct. 30, 2025

(30) Foreign Application Priority Data
Nov. 27, 2024 (JP) 2024-206454

(51) Int. Cl. B60S 1/02; B60S 1/56; H04N 23/90

(52) U.S. Cl. CPC B60S 1/026; B60S 1/56; H04N 23/90

(57) ABSTRACT

The in-vehicle imaging system includes a first camera and a second camera that are disposed to capture an image through a window glass of a vehicle, and an electric heating wire provided on a glass plate of the window glass. A focal length of the first camera is shorter than a focal length of the second camera. The first camera and the second camera are disposed such that a second angle of view region, which is a region of a glass plate that overlaps with the angle of view range of the second camera, is not positioned below a first angle of view region, which is a region of a glass plate that overlaps with the angle of view range of the first camera, and the first angle of view region and the second angle of view region have an overlapping portion.

### CROSS-REFERENCE TO RELATED APPLICATION

This application claims priority to Japanese Patent Application No. 2024-206454 filed on Nov. 27, 2024. The disclosure of the above-identified application, including the specification, drawings, and claims, is incorporated by reference herein in its entirety.

### BACKGROUND

### 1. Technical Field

The present disclosure relates to an in-vehicle imaging system and a vehicle window glass.

### 2. Description of Related Art

It has been known to provide a defogger on a glass plate for a window of a vehicle (Japanese Patent No. 7,259,747 (JP 7259747 B)). In the window glass described in JP 7259747 B, heating wires that constitute the defogger are disposed to surround a wiring-prohibited area positioned within an imaging range of a camera mounted on the vehicle. With such a disposition, the wiring-prohibited area is defogged by the heating wires positioned around the wiring-prohibited area.

### SUMMARY

In recent years, with the advancement of an advanced safety system, such as a collision mitigation brake, proposals have been made to provide two cameras, a wide-angle camera having a short focal length and a telephoto camera having a long focal length, in a vehicle. In such a vehicle, the angle of view region (imaging range) of the camera on the glass plate is a region obtained by combining both the angle of view region of the wide-angle camera and the angle of view region of the telephoto camera. Therefore, in the related art disclosed in JP 7259747 B, the wiring-prohibited area is increased, and thus it is not possible to appropriately suppress fogging in each of the angle of view regions of the wide-angle camera and the telephoto camera.

In consideration of the above problems, an object of the present disclosure is to appropriately suppress fogging in an angle of view region of two cameras having different focal lengths.

The gist of the present disclosure is as follows.
(1) An in-vehicle imaging system including
   a first camera and a second camera that are disposed to capture an image through a window glass of a vehicle and
   an electric heating wire provided on a glass plate of the window glass, in which a focal length of the first camera is shorter than a focal length of the second camera,
   the first camera and the second camera are disposed such that a second angle of view region that is a region of the glass plate overlapping with an angle of view range of the second camera is not positioned below a first angle of view region that is a region of the glass plate overlapping with an angle of view range of the first camera, and such that the first angle of view region and the second angle of view region have an overlapping portion, and
   the electric heating wire is disposed around the overlapping portion excluding the second angle of view region and a region of the glass plate positioned below the first angle of view region.
(2) The in-vehicle imaging system according to (1), in which the second camera is disposed such that an optical axis of the second camera is directed upward with respect to an optical axis of the first camera.
(3) The in-vehicle imaging system according to (2), in which the first camera and the second camera are disposed at the same height.
(4) The in-vehicle imaging system according to any one of (1) to (3), in which the electric heating wire is disposed to pass through the first angle of view region excluding the overlapping portion.
(5) A vehicle window glass that is attached to a vehicle equipped with a first camera and a second camera having a focal length longer than a focal length of the first camera, the vehicle window glass including
   a glass plate, and
   an electric heating wire that is disposed on the glass plate, in which the first camera and the second camera are provided in the vehicle to capture an image through the glass plate,
   the glass plate has a second angle of view region that is a region of the glass plate overlapping with an angle of view range of the second camera and a first angle of view region that is a region of the glass plate overlapping with an angle of view range of the first camera,
   the second angle of view region is not positioned below the first angle of view region, and the first angle of view region and the second angle of view region have an overlapping portion, and
   the electric heating wire is disposed around the overlapping portion excluding the second angle of view region and a region of the glass plate positioned below the first angle of view region.

According to the present disclosure, it is possible to appropriately suppress fogging in the angle of view region of the two cameras having different focal lengths.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view and a top cross-sectional view schematically showing a configuration around a window glass (windshield) of a vehicle;

FIG. 2 is a cross-sectional side view schematically showing a configuration around a window glass (windshield) of the vehicle;

FIG. 3 is a front view showing a part of a window glass of the vehicle in an enlarged manner;

FIG. 4 is a front view similar to FIG. 3 showing a part of the window glass of the vehicle in an enlarged manner; and

FIG. 5 is a diagram schematically showing an angle of view range by the telephoto camera.

### DETAILED DESCRIPTION OF EMBODIMENTS

Hereinafter, embodiments will be described in detail with reference to the drawings. In the following description, the same reference numerals are given to the same constituent elements.

### Configuration of In-Vehicle Imaging System

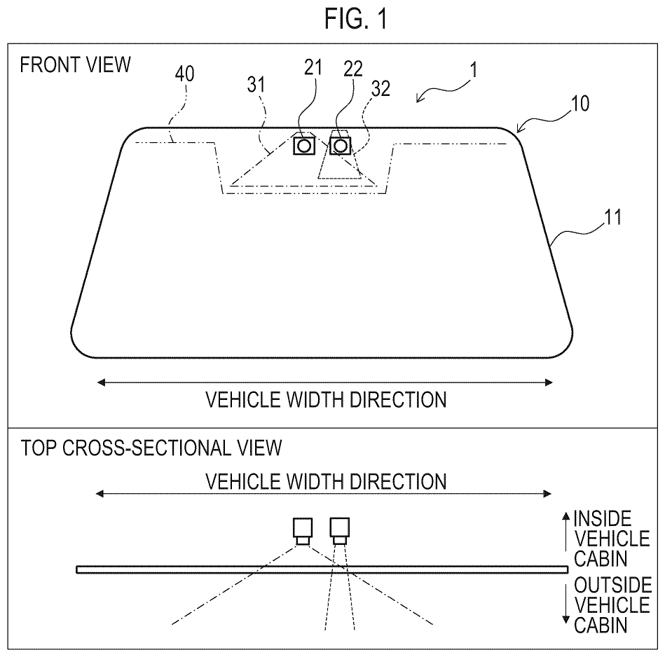

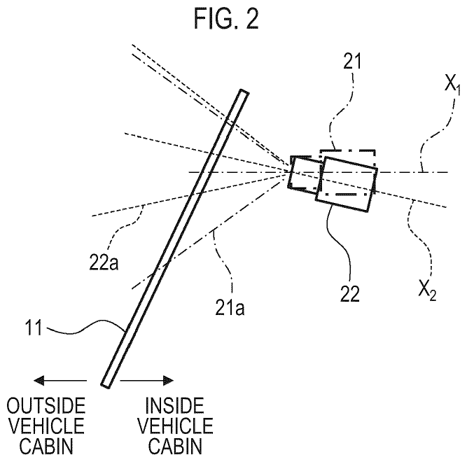

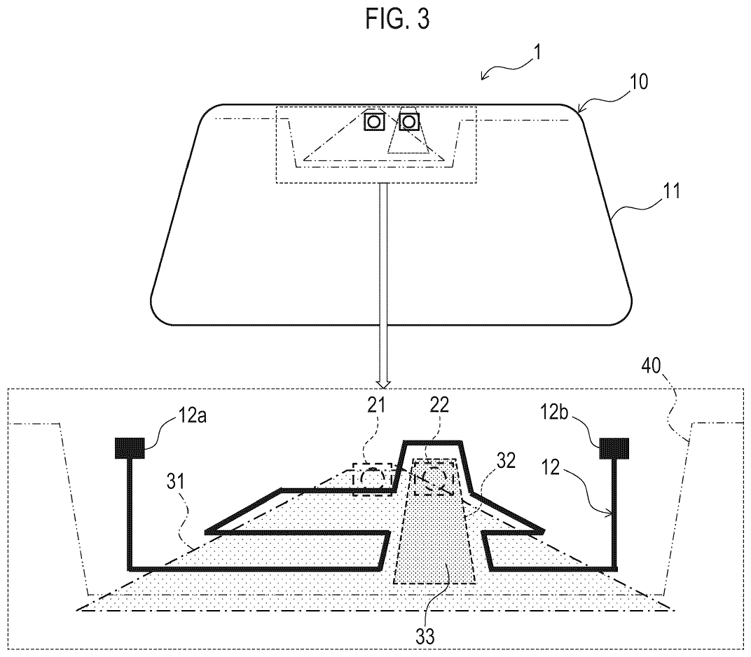

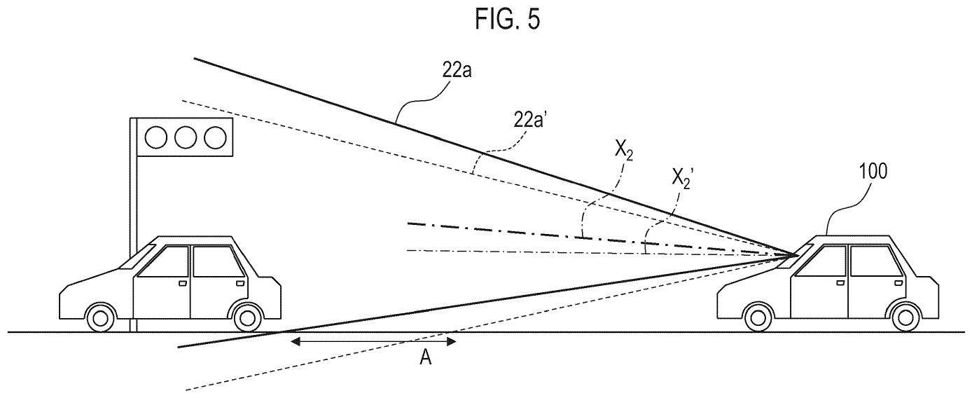

An in-vehicle imaging system 1 according to one embodiment will be described with reference to FIGS. 1 to 3. The in-vehicle imaging system 1 is a system mounted on a vehicle 100 (see FIG. 5) and configured to image a front of the vehicle 100. FIG. 1 is a front view and a top cross-sectional view schematically showing a configuration around a window glass (windshield) 10 for a vehicle 100. In addition, FIG. 2 is a cross-sectional side view schematically showing a configuration around the window glass (windshield) 10 of the vehicle 100. In addition, FIG. 3 is a front view showing a part of the window glass 10 of the vehicle 100 in an enlarged manner.

As shown in FIGS. 1 to 3, the in-vehicle imaging system 1 includes a plurality of cameras 21, 22 disposed to capture an image through a window glass 10 of a vehicle 100, and an electric heating wire 12 provided in a glass plate 11 of the window glass 10.

The window glass 10 is a windshield or a rear window disposed in front of or behind the vehicle 100. The window glass 10 includes a glass plate 11 made of glass and an electric heating wire 12 attached to the glass plate 11. The details of the electric heating wire 12 will be described below.

### Configuration of Camera

The cameras 21, 22 are disposed inside the vehicle 100 (inside the vehicle) and image the outside of the vehicle 100 through the window glass 10. In particular, in the present embodiment, the cameras 21, 22 image the front of the vehicle 100 through the windshield. However, the cameras 21, 22 may image the rear of the vehicle 100 through the rear window.

In particular, in the present embodiment, the in-vehicle imaging system 1 has two types of cameras, that is, a wide-angle camera (first camera) 21 and a telephoto camera (second camera) 22. The wide-angle camera 21 is a camera having a shorter focal length than the telephoto camera 22. Therefore, the angle of view range 21a of the wide-angle camera 21 (that is, the range in the angle direction imaged by the wide-angle camera 21) is wider than the angle of view range 22a of the telephoto camera 22 (that is, the range in the angle direction imaged by the telephoto camera 22) (see FIG. 2).

In the present embodiment, the in-vehicle imaging system 1 includes two cameras, that is, the wide-angle camera 21 and the telephoto camera 22. However, in a case where the focal length of a part of the cameras of the in-vehicle imaging system 1 is shorter than the focal length of the other cameras, the in-vehicle imaging system 1 may not have both the wide-angle camera and the telephoto camera, and may have three or more cameras. As described above, by having a plurality of cameras having different focal lengths, it is possible to provide a driving assistance system or an autonomous driving system that can perform advanced control.

As described above, the wide-angle camera 21 and the telephoto camera 22 image the outside of the vehicle 100 through the window glass 10, and therefore, as shown in FIGS. 1 and 2, the angle of view range 21a of the wide-angle camera 21 overlaps the glass plate 11 in the first angle of view region 31. Similarly, the angle of view range 22a of the telephoto camera 22 overlaps the glass plate 11 in the second angle of view region 32.

In the present embodiment, the wide-angle camera 21 captures a rectangular image. Further, as shown in FIG. 2, the glass plate 11 is inclined with respect to the optical axis X₁ of the wide-angle camera 21. Therefore, as shown in FIGS. 1 and 3, the first angle of view region 31 is a trapezoidal region. Similarly, the telephoto camera 22 captures a rectangular image. Further, as shown in FIG. 2, the glass plate 11 is inclined with respect to the optical axis X₂ of the telephoto camera 22. Therefore, as shown in FIGS. 1 and 3, the second angle of view region 32 is also a trapezoidal region.

In the present embodiment, as shown in FIGS. 1 and 2, the wide-angle camera 21 and the telephoto camera 22 are disposed immediately inside the window glass 10 near the upper portion of the window glass 10. In addition, the wide-angle camera 21 and the telephoto camera 22 are disposed adjacent to each other near the center in the vehicle width direction. As a result, the wide-angle camera 21 and the telephoto camera 22 can more appropriately detect the environment around the vehicle 100, particularly the environment in front of the vehicle 100. As a result, as shown in FIGS. 1 and 3, the first angle of view region 31 of the wide-angle camera 21 and the second angle of view region 32 of the telephoto camera 22 partially overlap each other. That is, the wide-angle camera 21 and the telephoto camera 22 are disposed to have an overlapping portion 33 in which the first angle of view region 31 of the wide-angle camera 21 and the second angle of view region 32 of the telephoto camera 22 overlap each other.

Further, in the present embodiment, as shown in FIG. 2, the wide-angle camera 21 and the telephoto camera 22 are disposed such that the heights in the vertical direction (the height direction of the vehicle 100) are substantially the same. In particular, in the present embodiment, the lens of the wide-angle camera 21 and the lens of the telephoto camera 22 are disposed to be positioned at substantially the same height.

In addition, in the present embodiment, as shown in FIG. 2, the wide-angle camera 21 and the telephoto camera 22 are disposed such that the optical axis X₂ of the telephoto camera 22 is directed upward with respect to the optical axis X₁ of the wide-angle camera 21. In particular, in the present embodiment, the wide-angle camera 21 is disposed such that the optical axis X₁ thereof is substantially horizontal, and the telephoto camera 22 is disposed such that the optical axis X₂ thereof is inclined upward more than horizontal.

As described above, in the present embodiment, the wide-angle camera 21 and the telephoto camera 22 are disposed at the same height, and the optical axis X₂ of the telephoto camera 22 is disposed to be directed upward with respect to the optical axis X₁ of the wide-angle camera 21. As a result, the lower end of the second angle of view region 32 of the telephoto camera 22 is positioned above the lower end of the first angle of view region 31 of the wide-angle camera 21. In other words, in the present embodiment, the wide-angle camera 21 and the telephoto camera 22 are disposed such that the second angle of view region 32 of the telephoto camera 22 is not positioned below the first angle of view region 31 of the wide-angle camera 21.

The wide-angle camera 21 and the telephoto camera 22 may be disposed in any manner as long as the wide-angle camera 21 has an overlapping portion 33 in which the first angle of view region 31 of the wide-angle camera 21 and the second angle of view region 32 of the telephoto camera 22 overlap each other and the second angle of view region 32 of the telephoto camera 22 is not positioned below the first angle of view region 31 of the wide-angle camera 21. Therefore, in a case where the optical axis X₂ of the telephoto camera 22 is disposed to be upward with respect to the optical axis X₁ of the wide-angle camera 21, the wide-angle camera 21 may be disposed such that the optical axis X₁ is not horizontal. The wide-angle camera 21 and the telephoto camera 22 may not be disposed at the same height, and for example, the telephoto camera 22 may be disposed above the wide-angle camera 21. Further, the optical axis X₂ of the telephoto camera 22 may be disposed to be parallel to the optical axis X₁ of the wide-angle camera 21 or to be directed downward from the optical axis X₁ of the wide-angle camera 21.

### Configuration of Electric Heating Wire

Next, the configuration of the electric heating wire 12 will be described with reference to FIG. 3.

Here, the glass plate 11 may be fogged due to a temperature difference or the like between the inside and the outside of the vehicle cabin or the like. In particular, when the first angle of view region 31 and the second angle of view region 32 on the glass plate 11 are fogged, the imaging performance of the wide-angle camera 21 and the telephoto camera 22 is deteriorated. Therefore, in the present embodiment, the defogging of the first angle of view region 31 and the second angle of view region 32 is performed by the electric heating wire 12.

In the present embodiment, the electric heating wire 12 is printed on the glass plate 11. The electric heating wire 12 is formed of a conductor containing silver as a main component, for example.

As shown in FIG. 3, the electric heating wire 12 includes electrode terminals 12a, 12b. The electrode terminals 12a, 12b are connected to a power source. When a current flows through the electric heating wire 12 between the electrode terminals 12a, 12b, the electric heating wire 12 generates heat. In addition, around the electric heating wire 12, the droplets on the surface of the glass plate 11 evaporate due to the heat transmitted from the electric heating wire 12, and as a result, fogging around the electric heating wire 12 is suppressed.

By the way, since the defogging using the electric heating wire is performed by the heat from the electric heating wire being transmitted to the region to be defogged, the electric heating wire is generally wired to pass through the region to be defogged. However, when the heat by the electric heating wire is transmitted to the glass plate 11, a temperature gradient occurs in the glass plate 11, and distortion occurs in glass plate 11. In addition, when the distortion of the glass plate 11 occurs in the angle of view region of the camera, there is a possibility that the imaging performance of the camera is deteriorated. The decrease in imaging performance of the camera due to the distortion of the glass plate 11 varies depending on the characteristics of the camera.

Here, the wide-angle camera 21 has a short focal length, and thus a short distance between the lens and the image sensor. For this reason, for example, even in a case where the distortion occurs in the first angle of view region 31 of the glass plate 11 disposed in front of the wide-angle camera 21 and the light passing through the distortion is inappropriately refracted, the focal length is short, and thus the deviation of the light that finally occurs in the image sensor due to the refraction is not so large. Therefore, in the wide-angle camera 21, the influence of the distortion in the glass plate 11 on the generated image is relatively small.

On the other hand, the telephoto camera 22 has a long focal length, and thus the distance between the lens and the image sensor is longer. Therefore, for example, in a case where the distortion occurs in the second angle of view region 32 of the glass plate 11 disposed in front of the telephoto camera 22 and the light passing through the distortion is inappropriately refracted, the focal length is long, and thus the deviation of the light that finally occurs in the image sensor due to the refraction is large. Therefore, in the telephoto camera 22, the influence of the distortion in the glass plate 11 on the generated image is relatively large.

In addition, the window glass 10 of the vehicle 100, particularly the windshield is used for the driver to see the traveling direction during driving of the vehicle 100. Therefore, it is preferable that the electric heating wire that obstructs the field of view of the driver is not disposed in the region from the center of the window glass 10 in the vertical direction to the lower side. Therefore, it is preferable that the electric heating wire is not disposed in a region below the visibility boundary line 40 in FIG. 1 and FIG. 3 as a region for securing the field of view of the driver.

Therefore, in the present embodiment, the electric heating wire 12 is disposed as follows in consideration of the influence of the distortion of the glass plate 11 on the imaging performance of each of the cameras 21, 22 and the field of view of the driver.

First, in the present embodiment, the electric heating wire 12 is not disposed in the second angle of view region 32 of the telephoto camera 22. As a result, in the second angle of view region 32 of the telephoto camera 22, a large distortion due to the temperature gradient in the glass plate 11 is suppressed. As a result, it is possible to suppress the deterioration of the imaging performance of the telephoto camera 22.

In the present embodiment, the electric heating wire 12 is disposed in the first angle of view region 31 of the wide-angle camera 21. Note that, even in the first angle of view region 31, the electric heating wire 12 is not disposed in the overlapping portion 33 with the second angle of view region 32. As can be seen from FIGS. 1 and 3, since the first angle of view region 31 is relatively wide, the clouding in the first angle of view region can be suppressed by heating the first angle of view region 31 using the electric heating wire. Further, as described above, in the wide-angle camera 21, the influence of the distortion in the glass plate 11 on the generated image is relatively small. Therefore, it is possible to suppress the decrease in imaging performance of the wide-angle camera 21 and perform defogging in the imaging range of the wide-angle camera 21.

In addition, in the present embodiment, the electric heating wire 12 is disposed around the overlapping portion 33. As described above, the electric heating wire 12 is not disposed in the second angle of view region 32 including the overlapping portion 33, but the electric heating wire 12 is disposed around the overlapping portion 33, so that a certain degree of heat is also transmitted to the overlapping portion 33. As a result, the overlapping portion 33 is heated without a temperature gradient that causes a large distortion in the glass plate 11, and thus the antifogging performance can be secured. In particular, since the second angle of view region 32 of the telephoto camera 22 is relatively narrow, the defogging can be sufficiently performed by merely disposing the electric heating wire 12 around the overlapping portion 33.

Note that, in the present embodiment, the electric heating wire 12 is not disposed in the second angle of view region 32 of the telephoto camera 22 even around the overlapping portion 33. A decrease in imaging performance of the telephoto camera 22 due to the disposition of the electric heating wire in the second angle of view region 32 is suppressed.

In the present embodiment, the electric heating wire 12 is not disposed in the region below the visibility boundary line 40 even around the overlapping portion 33. In particular, in the present embodiment, the lower end of the first angle of view region 31 of the wide-angle camera 21 extends to the vicinity of the visibility boundary line 40 or beyond the visibility boundary line 40 (in the example shown in FIG. 3, beyond the visibility boundary line 40). Therefore, in the present embodiment, the wide-angle camera 21 is not disposed in the region of the glass plate 11 that is positioned below the first angle of view region 31 of the wide-angle camera 21 even around the overlapping portion 33. As a result, the obstruction of the field of view of the driver by the electric heating wire 12 is suppressed. In the present embodiment, the telephoto camera 22 is disposed such that the second angle of view region 32 does not extend downward beyond the lower end of the visibility boundary line 40.

Therefore, in the present embodiment, as shown in FIG. 3, the electric heating wire 12 is disposed around the overlapping portion 33 excluding the second angle of view region 32 and the region of the glass plate 11 positioned below the first angle of view region 31. The electric heating wire 12 may be disposed around the entire periphery of the overlapping portion 33 excluding the second angle of view region 32 and the region of the glass plate 11 positioned below the first angle of view region 31. The electric heating wire 12 may be disposed on a part of the periphery of the overlapping portion 33 excluding the second angle of view region 32 and the region of the glass plate 11 positioned below the first angle of view region 31.

### Effect

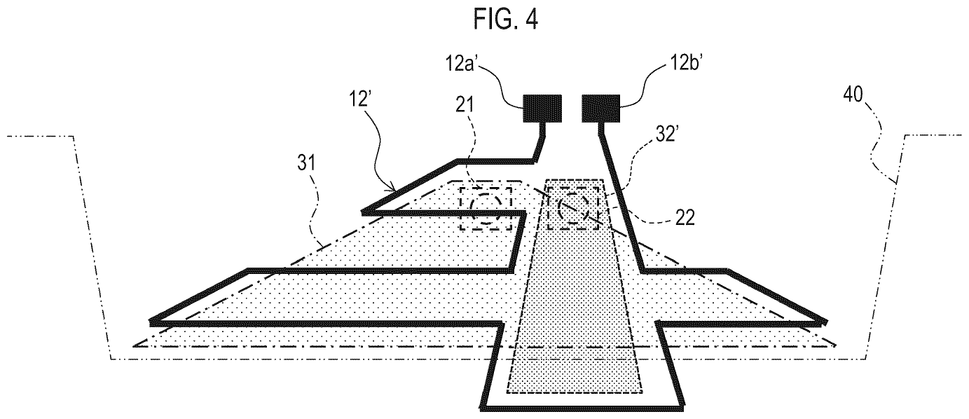

By the way, in a case where the optical axis X₁ of the wide-angle camera 21 and the optical axis X₂ of the telephoto camera 22 are made parallel to each other, the second angle of view region of the telephoto camera 22 may be positioned downward as compared with the above-described embodiment. This state is shown in FIG. 4. FIG. 4 is a front view similar to FIG. 3 showing a part of the window glass 10 of the vehicle 100 enlarged.

When the optical axis X₁ of the wide-angle camera 21 and the optical axis X₂ of the telephoto camera 22 are made parallel to each other, as shown in FIG. 4, the second angle of view region 32′ of the telephoto camera 22 may be positioned below the first angle of view region 31 of the wide-angle camera 21. In particular, in the example shown in FIG. 4, since the lower end of the first angle of view region 31 of the wide-angle camera 21 extends to the vicinity of the visibility boundary line 40, the second angle of view region 32′ of the telephoto camera 22 extends beyond the visibility boundary line 40. Therefore, in this case, when the electric heating wire 12′ is disposed around the second angle of view region 32′, as shown in FIG. 4, the electric heating wire 12′ extends downward to the visibility boundary line 40, which obstructs the field of view of the driver. On the other hand, in a case where the electric heating wire 12′ is not disposed around the second angle of view region 32′ of the telephoto camera 22 for a portion below the visibility boundary line 40 so as not to obstruct the field of view of the driver, it is not possible to appropriately suppress fogging in the portion of the second angle of view region 32′ below the visibility boundary line 40.

In contrast, in the above-described embodiment, the wide-angle camera 21 and the telephoto camera 22 are disposed such that the second angle of view region 32 of the telephoto camera 22 is not positioned below the first angle of view region 31 of the wide-angle camera 21. Therefore, the second angle of view region 32 of the telephoto camera 22 is not positioned below the visibility boundary line 40. Therefore, the electric heating wire does not obstruct the field of view of the driver and it is possible to appropriately suppress fogging in the portion of the second angle of view region below the visibility boundary line 40.

In the above-described embodiment, the wide-angle camera 21 and the telephoto camera 22 are disposed such that the optical axis X₂ of the telephoto camera 22 is directed upward with respect to the optical axis X₁ of the wide-angle camera 21. As a result, the angle of view range of the telephoto camera 22 changes as compared with a case where the optical axis X₁ of the wide-angle camera 21 and the optical axis X₂ of the telephoto camera 22 are parallel to each other.

FIG. 5 is a diagram schematically showing an angle of view range by the telephoto camera 22. X₂ and 22a in the figure respectively indicate the optical axis and the angle of view range when the optical axis of the telephoto camera 22 is directed upward more than horizontal. On the other hand, X₂′ and 22a′ in the figure indicate the optical axis and the angle of view range when the optical axis of the telephoto camera 22 is made horizontal (parallel to the optical axis X₁ of the wide-angle camera 21), respectively.

Here, the telephoto camera 22 is generally mounted to recognize a distant traffic light, a sign, and a preceding vehicle in the distance. As shown in FIG. 5, even when the optical axis of the telephoto camera 22 is directed upward, a part of the road A goes out of the angle of view range, and a distant traffic light, sign, preceding vehicle, and the like are within the angle of view range of the telephoto camera 22. Therefore, although the road A that is not used even when the road A is imaged is not imaged, the telephoto camera 22 can image a distant traffic light, a traffic sign, a preceding vehicle, or the like, and thus the substantial influence of the upward tilting of the optical axis of the telephoto camera 22 is small.

In addition, normally, the wide-angle camera 21 and the telephoto camera 22 are disposed above the rear portion of the windshield, and there is often a mounting restriction in the vertical direction. In the above-described embodiment, the wide-angle camera 21 is disposed at the same height as the telephoto camera 22. Therefore, the height of the entire wide-angle camera 21 and the entire telephoto camera 22 in the vertical direction can be minimized, and the mountability can be improved.

Although the preferred embodiments of the present disclosure have been described, the present disclosure is not limited to the embodiments, and various changes and modifications can be made within the scope of the claims.

What is claimed is:

1. An in-vehicle imaging system comprising:
a first camera and a second camera that are disposed to capture an image through a window glass of a vehicle; and
an electric heating wire provided on a glass plate of the window glass, wherein:
a focal length of the first camera is shorter than a focal length of the second camera;
the first camera and the second camera are disposed such that a second angle of view region that is a region of the glass plate overlapping with an angle of view range of the second camera is not positioned below a first angle of view region that is a region of the glass plate overlapping with an angle of view range of the first camera, and such that the first angle of view region and the second angle of view region have an overlapping portion; and
the electric heating wire is disposed around the overlapping portion excluding the second angle of view region and a region of the glass plate positioned below the first angle of view region.

2. The in-vehicle imaging system according to claim 1, wherein the second camera is disposed such that an optical axis of the second camera is directed upward with respect to an optical axis of the first camera.

3. The in-vehicle imaging system according to claim 2, wherein the first camera and the second camera are disposed at the same height.

4. The in-vehicle imaging system according to claim 1, wherein the electric heating wire is disposed to pass through the first angle of view region excluding the overlapping portion.

5. A vehicle window glass that is attached to a vehicle equipped with a first camera and a second camera having a focal length longer than a focal length of the first camera, the vehicle window glass comprising:
a glass plate; and
an electric heating wire that is disposed on the glass plate, wherein:
the first camera and the second camera are provided in the vehicle to capture an image through the glass plate;
the glass plate has a second angle of view region that is a region of the glass plate overlapping with an angle of view range of the second camera and a first angle of view region that is a region of the glass plate overlapping with an angle of view range of the first camera;
the second angle of view region is not positioned below the first angle of view region, and the first angle of view region and the second angle of view region have an overlapping portion; and
the electric heating wire is disposed around the overlapping portion excluding the second angle of view region and a region of the glass plate positioned below the first angle of view region.
